(19) United States
(12) Patent Application Publication
(10) Pub. No.: US 2001/0049724 A1
(43) Pub. Date: Dec. 6, 2001

(54) System and method for managing data within a database

(75) Inventor: Kevin R. Marcus, Woodinville, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: InfoSpace, Inc..

(21) Appl. No.: 09/851,010

(22) Filed: May 7, 2001

Related U.S. Application Data
(63) Continuation-in-part of application No. 09/207,391, filed on Dec. 8, 1998, now Pat. No. 6,230,188.

(51) Int. Cl. G06F 15/16

(52) U.S. Cl. 709/206

(57) ABSTRACT

A system and method for managing data within a database are provided. A client computer transmits an execution request to an information processing server. The information processing server obtains the request and identifies a database record index associated with the execution request. The processed execution request is transmitted to the client computing device without the database record index.

### CROSS-REFERENCE TO RELATED APPLICATION

This is a continuation in part of U.S. application Ser. No. 09/207,391 entitled ON-LINE DIRECTORY SERVICE, filed Dec. 8, 1998. U.S. application Ser. No. 09/207,391 is incorporated by reference herein.

### FIELD OF THE INVENTION

The present invention relates to database management, and more particularly, to a system and method for managing data within a database.

### BACKGROUND OF THE INVENTION

Various types of commercial database services are available to distribute a variety of information to general public. In a conventional embodiment in which access to a database is unrestricted, a user can access a variety of data contained within the database by utilizing a database record index to retrieve one or more appropriate fields within the database. Additionally, the user can perform various actions of the database, such as sorting, searching, linking and the like, by manipulating one or more database record indexes.

The ability to perform specific actions on a set of relational databases can assist a variety of special use needs. For example, in a security embodiment, it may be beneficial for a user, such as a security guard, to have access to individual data on a database to facilitate a variety of security functions. For example, a security guard may be able to access a database and confirm car registration information. At the same time, however, it would also be beneficial from the perspective of the individual to limit the data that can be retrieved or to prevent the user from editing the data within the database.

In a commercial transaction embodiment, it may be beneficial to allow for the transfer of funds between two individuals without each individual disclosing private bank account/credit account information to one another. For example, in a commercial transaction occurring over the Internet, a first individual registered with a database may wish to have funds transferred to another individual registered with the database utilizing an acceptable public identifier, such as the person's name, address, or telephone number, without divulging more private information, such as bank account numbers, etc.

In the above-described embodiments, providing third party users with one or more database record indexes in an unrestricted embodiment, however, raises various issues regarding the privacy and security of the information contained within the database. With regard to the security embodiment, although the database record index may be intended to be used solely to allow access to limited portions of data contained within a database record, a third party may be able to manipulate the data within the database and/or access additional data not intended to be given to that particular third party user. Similarly, with regard to the commercial transaction embodiment, access to a database record index can divulge more user financial information than necessary and/or place the security of an individual's bank account into question.

Thus, a need exists for a database management system that allows for the execution of database requests without divulging a database record index.

### SUMMARY OF THE INVENTION

A system and method for managing data within a database are provided. A client computer transmits an execution request to an information processing server. The information processing server obtains the request and identifies a database record index associated with the execution request. The processed execution request is transmitted to the client computing device without the database record index.

In accordance with an aspect of the present invention, a method for executing a request on a database is provided. An information processing server obtains a database execution request from a client computing device. The information processing server identifies a database record index associated with the corresponding record in the database. The information processing server processes the execution request with the identified database record index.

In accordance with another aspect of the present invention, a system for processing database execution requests is provided. The system includes at least one client computing device operable to generate a database execution request. The system also includes an information processing system operable to obtain the execution request and identify a database record index corresponding to the execution request. The information processing system is further operable to process the execution request with the identified database record index and the database execution request does not include the identified database record index.

In accordance with a further aspect of the present invention, a method for executing a request on a database is provided. An information processing system obtains a database execution request from a client computing device. The execution request includes a proxy database record index. The information processing system correlates a database record index to the proxy database record index. The information processing system processes the execution request with the database record index.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram representative of the Internet;

FIG. 2 is a block diagram illustrative of data request system in accordance with the present invention;

FIG. 3 is a state diagram illustrating the processing of an execution request by an information processing server in accordance with the present invention;

FIG. 4 is a state diagram illustrating the processing of an execution request by an information processing server utilizing a database object in accordance with the present invention;

FIG. 5 is a block diagram depicting an illustrative architecture for a client computing device utilized generate execution requests in accordance with the present invention;

FIG. 6 is a block diagram depicting an illustrative architecture for a information processing server utilized to process execution requests generated by client computing devices in accordance with the present invention; and

FIG. 7 is a flow diagram illustrative of a database execution request processing routine in accordance with the present invention.

### DETAILED DESCRIPTION OF AN ILLUSTRATIVE EMBODIMENT

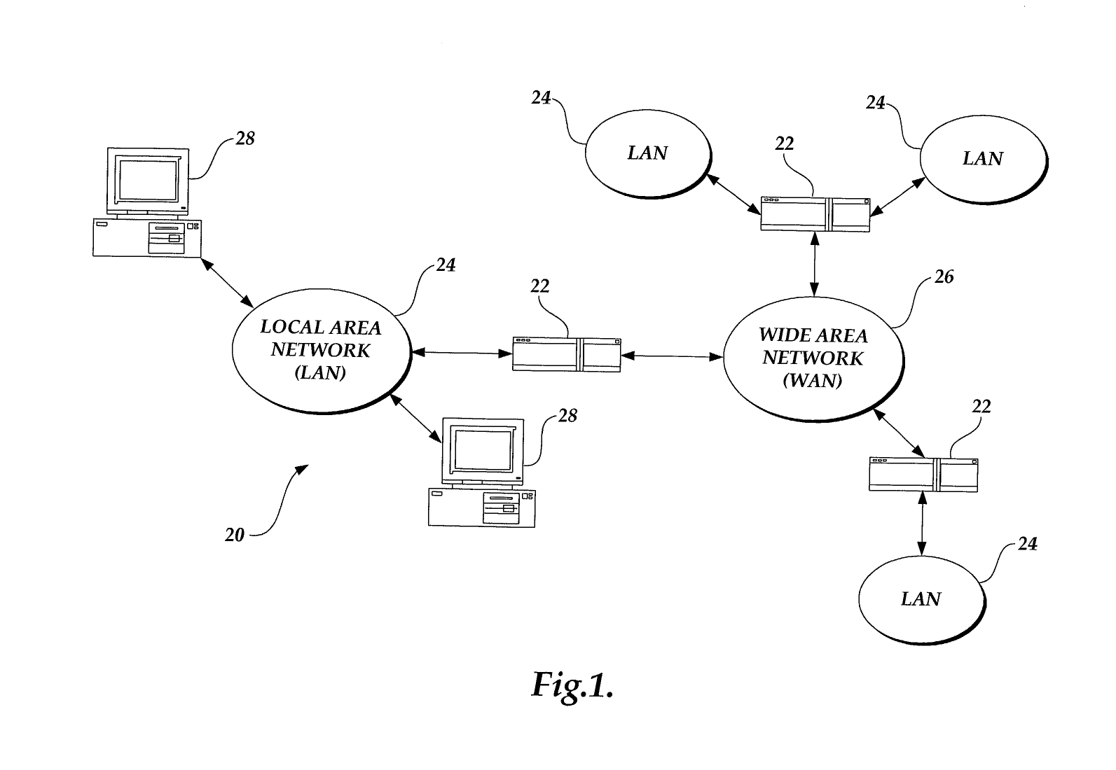

As described above, aspects of the present invention are embodied in a WWW site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, in which a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, or coaxial cable, while communication links between networks may utilize 56 Kbps analog telephone lines, 1 Mbps digital T-1 lines, 45 Mbps T-3 lines or other communications links known to those skilled in the art. Furthermore, computers 28 and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”), or other markup languages, that are electronically stored at “WWW sites” or “Web sites” throughout the Internet. A WWW site is a server connected to the Internet that has mass storage facilities for storing hypertext documents and that runs administrative software for handling requests for those stored hypertext documents. A hypertext document normally includes a number of hyperlinks, i.e., highlighted portions of text which link the document to another hypertext document possibly stored at a WWW site elsewhere on the Internet. Each hyperlink is associated with a Uniform Resource Locator (“URL”) that provides the exact location of the linked document on a server connected to the Internet and describes the document. Thus, whenever a hypertext document is retrieved from any WWW server, the document is considered to be retrieved from the WWW. As is known to those skilled in the art, a WWW server may also include facilities for storing and transmitting application programs, such as application programs written in the JAVA® programming language from Sun Microsystems, for execution on a remote computer. Likewise, a WWW server may also include facilities for executing scripts and other application programs on the WWW server itself.

A consumer or other remote user may retrieve hypertext documents from the WWW via a WWW browser application program. A WWW browser, such as Netscape's NAVIGATOR® or Microsoft's Internet Explorer, is a software application program for providing a graphical user interface to the WWW. Upon request from the consumer via the WWW browser, the WWW browser accesses and retrieves the desired hypertext document from the appropriate WWW server using the URL for the document and a protocol known as HyperText Transfer Protocol (“HTTP”). HTTP is a higher-level protocol than TCP/IP and is designed specifically for the requirements of the WWW. It is used on top of TCP/IP to transfer hypertext documents between servers and clients. The WWW browser may also retrieve application programs from the WWW server, such as JAVA applets, for execution on the client computer.

The present invention relates to a system and method for manipulating database information from a computing device without having access to the database record index. Specifically, in an illustrative embodiment of the present invention, a system and method for manipulating database information via a proxy database processing system are provided. One skilled in the relevant art will appreciate that the disclosed embodiment is done for illustrative purposes and should not be construed as limiting.

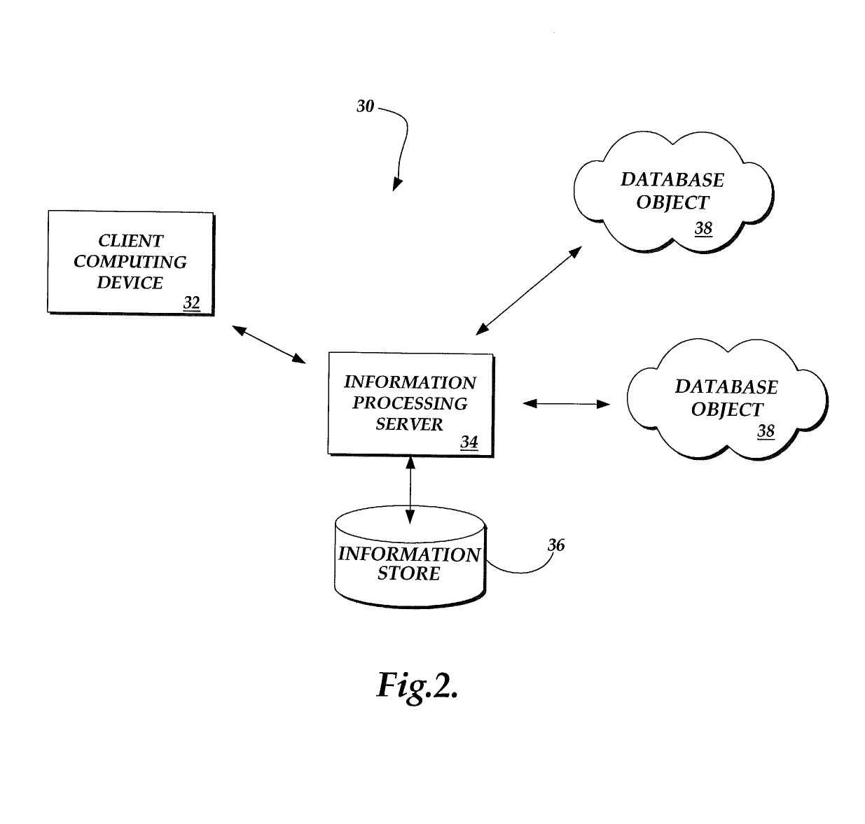

FIG. 2 is a block diagram illustrative of a proxy database processing system 30 in accordance with the present invention. With reference to FIG. 2, the proxy database processing system 30 includes a client computing device 32 in communication with an information processing server 34. In an illustrative embodiment of the present invention, the client computing device 32 generates execution requests for manipulation of database data without submitting the database record index required to fulfill the execution request. The information processing server 34 obtains the execution request from the client computing device 32, identifies the appropriate data and a corresponding database record index and processes the execution request accordingly.

In an actual embodiment of the present invention, the information processing server 34 processes a portion or all of the execution request utilizing databases contained within an information store 36. One skilled in the art will appreciate that the information store may be one or more databases that are in direct communication with the information processing server 34. The databases included information store 36 may local and/or remote from the information processing server 34 and may be in communication with the information processing server 34 via a variety of communication media, including, but not limited to the Internet 20, private hardwire networks, and wireless networks.

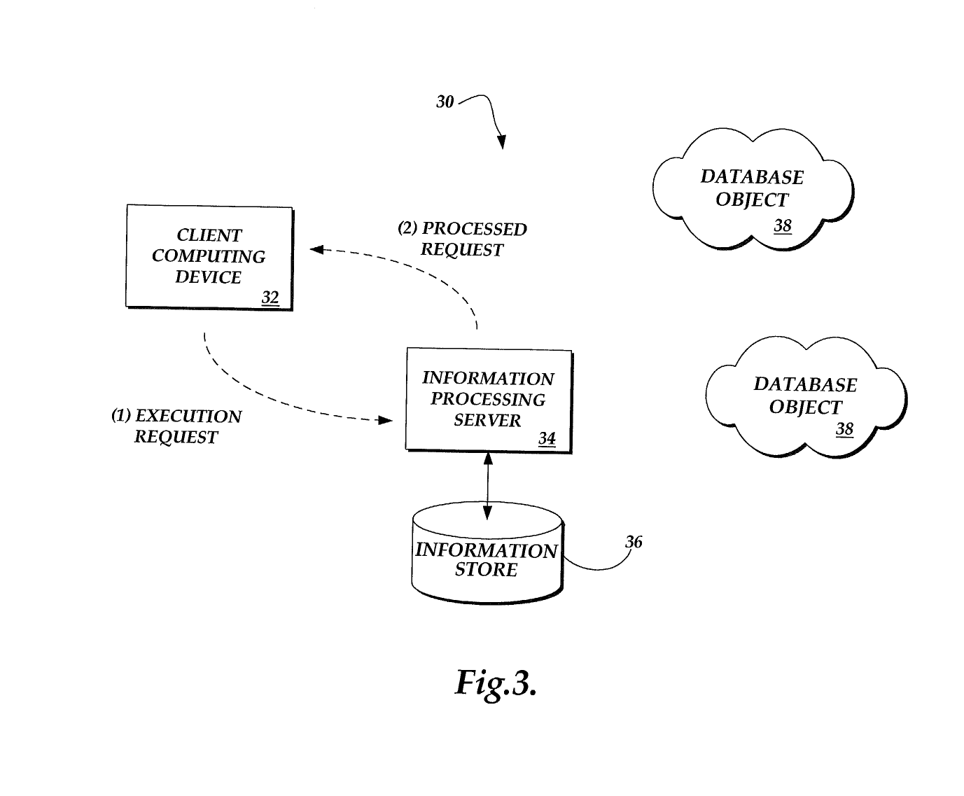

FIG. 3 is a state diagram illustrating the processing of an execution request by the information processing server 34 in accordance with the present invention. The client computing device 32 issues the execution request to the information processing server 34. The information processing server 34 obtains the execution request and accesses the appropriate data from the information store 36. The information processing server 34 processes the data according to the execution request, and the processed request is returned to the client computing device 32.

Returning to FIG. 2, the information processing server 34 also communicates with one or more database objects 38 that are operable to process the client computing device 32 execution request. In an actual embodiment of the present invention, the information processing server 34 may utilize one or more database objects 38 to process the client computing device 32 execution request. For example, the database objects 38 may include private data that the information processing server 34 may not be given direct access to. Alternatively, the information processing server 34 may also utilize the database objects 38 to distribute the execution requests, especially if the information processing server 34 is servicing several client computing devices 32.

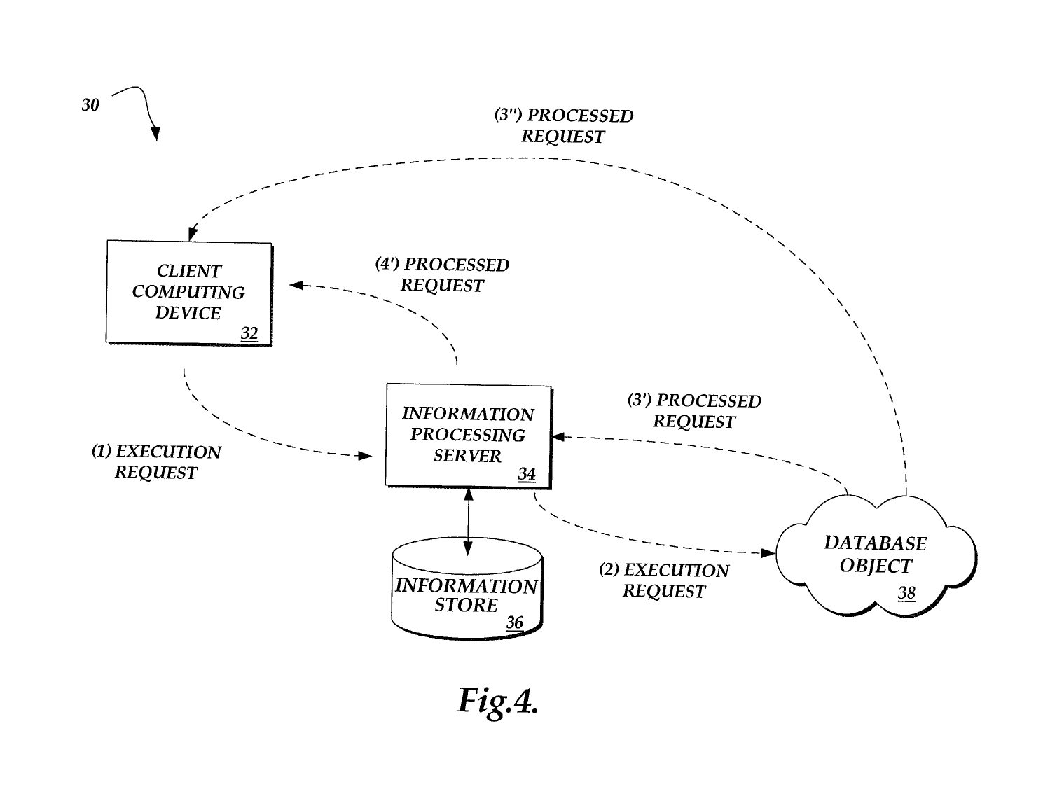

FIG. 4 is a state diagram illustrating the processing of an execution request by the information processing server 34 utilizing a database object 38 in accordance with the present invention. As similarly described with respect to FIG. 3, the client computing device 32 issues the execution request to the information processing server 34. However, in this embodiment, the information processing server 34 obtains the execution request and transmits the execution request to one or more database objects 38, which maybe remote from the information processing server. In an actual embodiment of the present invention, the information processing server 34 may also modify the execution request by providing the actual database record index to facilitate the processing of the execution request. Accordingly, the database object 38 may process the execution request to determine an appropriate database record index.

Once the database object 38 processes the execution request, in one embodiment, the processing request is transmitted to the information processing server 34, which subsequently transmits the processed execution request to the client computing device 32. In another embodiment, the database object 38 may return the processed execution request directly to the client computing device 32.

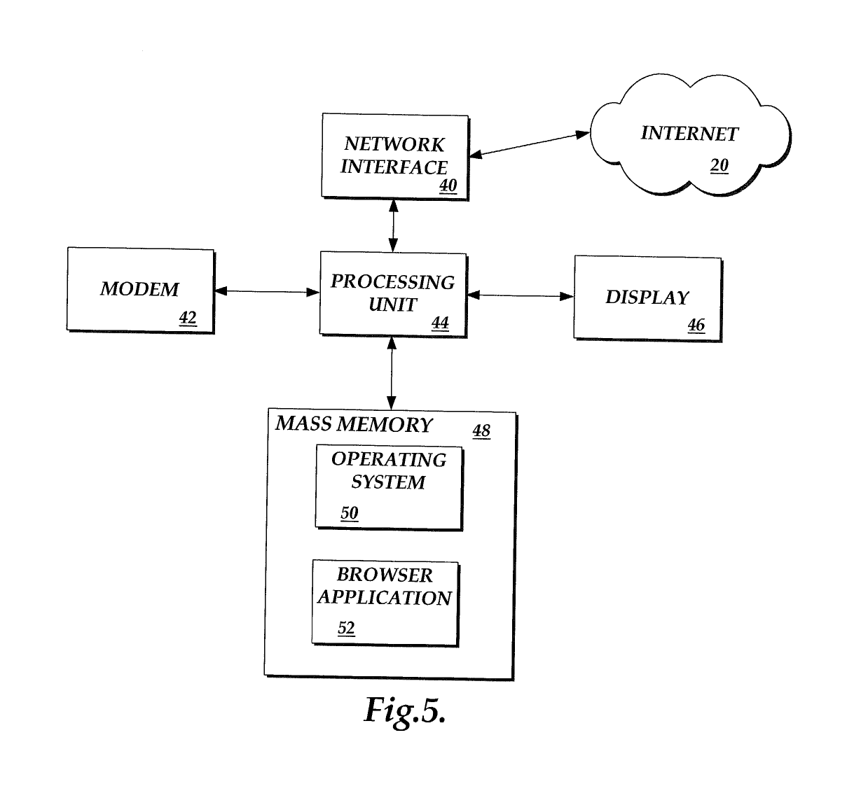

FIG. 5 is a block diagram depicting an illustrative architecture for a client computing device 32 utilized generate execution requests in accordance with the present invention. Those of ordinary skill in the art will appreciate that the computing device 32 includes many more components then those shown in FIG. 5. However, it is not necessary that all of these generally conventional components be shown in order to disclose an illustrative embodiment for practicing the present invention. As shown in FIG. 5, the client computing device 32 includes a network interface 40 for connecting directly to a LAN 24 or a WAN 26, or for connecting remotely to a LAN or WAN. Those of ordinary skill in the art will appreciate that the network interface 40 includes the necessary circuitry for such a connection, and is also constructed for use with the TCP/IP protocol, the particular network configuration of the LAN 24 or WAN 26 it is connecting to, and a particular type of coupling medium. The client computing device 32 may also be equipped with a modem 42 for connecting to the Internet 20 through a point-point protocol (“PPP”) connection or a serial line Internet protocol (“SLIP”) connection as known to those skilled in the art.

The client computing device 32 also includes a processing unit 44, a display 46, and a mass memory 48, all connected via a communication SLS, or other communication device. The mass memory 48 generally comprises a RAM, ROM, and a permanent mass storage device, such as a hard disk drive, tape drive, optical drive, floppy disk drive, or combination thereof. The mass memory 48 stores an operating system 50 for controlling the operation of the computing device. It will appreciated that this component may comprises a general-purpose operating system as is known to those skilled in the art, such as UNIX, LINUX™, or Microsoft WINDOWS NT®. The memory 48 also includes a WWW browser 52, such as Netscape's NAVIGATOR® or Microsoft's Internet Explorer browsers, for accessing the WWW. In an actual embodiment of the present invention, the client computing device 32 interacts with the information processing server 34 via one or more graphical user interfaces generated by the WWW browser application 52. Alternatively, the client computing device 32 may have one or more resident software application in mass memory for interfacing with the information processing server 32.

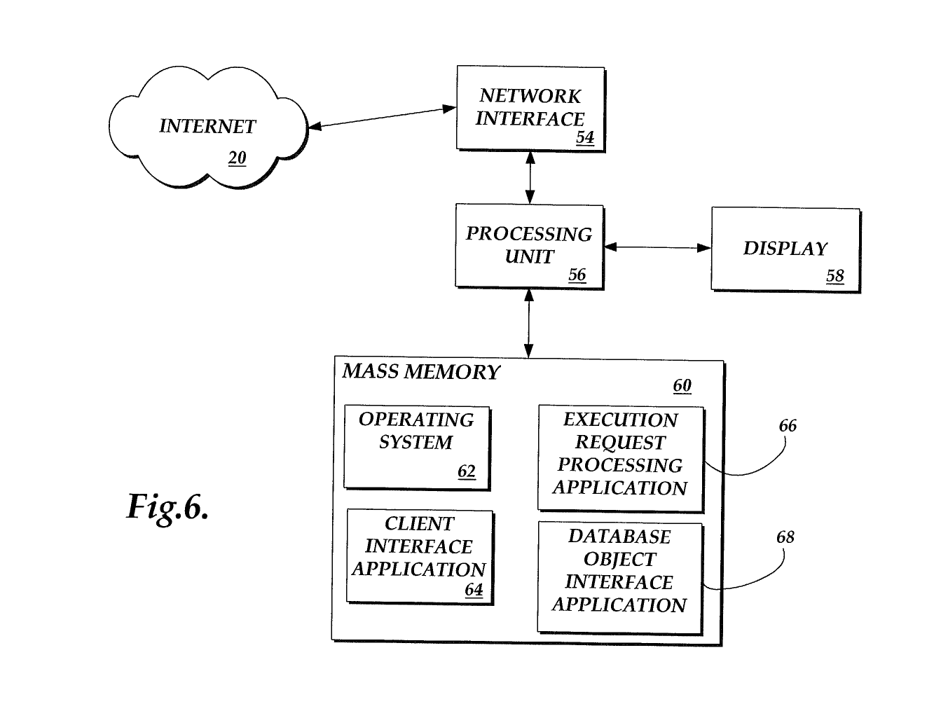

FIG. 6 is a block diagram depicting an illustrative architecture for an information processing server 34 (FIG. 2) utilized to process execution requests generated by client computing devices in accordance with the present invention. Those of ordinary skill in the art will appreciate that the information processing server 34 includes many more components than those shown in FIG. 6. However, it is not necessary that all of these generally conventional components be shown in order to disclose an illustrative embodiment for practicing the present invention. As shown in FIG. 6, the information processing server 34 is connected to the Internet 20 via a network interface 54. Those of ordinary skill in the art will appreciate that the network interface 54 includes the necessary circuitry for connecting the information processing server 34 to the Internet 20, and is constructed for use with the TCP/IP protocol.

The information processing server 34 also includes a processing unit 56, an optional display 58, and a mass memory 60, all connected via a communication bus, or other communication device. The mass memory 60 generally comprises a RAM, ROM, and a permanent mass storage device, such as a hard disk drive, tape drive, optical drive, floppy disk drive, or combination thereof. The mass memory 60 stores an operating system 62 for controlling the operation of the information processing server 34. It will be appreciated that this component may comprise a general purpose server operating system as is known to those of ordinary skill in the art, such as UNIX, LINUX™, or Microsoft WINDOWS NT®.

The mass memory 60 also stores the program code and data for communicating with the client computing device 32 and database objects 38 and for processing execution requests in accordance with the present invention. More specifically, the mass memory 60 stores a client interface application 64 for interfacing with client computing device 32. The operation of the client interface application 64 will be described in greater detail as described below. The mass memory 60 also stores an execution request processing application 66. The execution request processing application 66 comprises computer executable instructions which, when executed by the information processing server 34, process the execution request by the client computing device 32. The mass memory 60 further stores a database object interface application 68. The database object interface application 68 comprises computer-executable instructions which, when executed by the information processing application, facilitates interfacing with various database objects 38. It will be appreciated that these components may be stored on a computer-readable medium and loaded into the memory 60 of the information processing server 34 using a drive mechanism associated with the computer-readable medium, such as a floppy, CD-ROM, DVD-ROM drive, or the network interface.

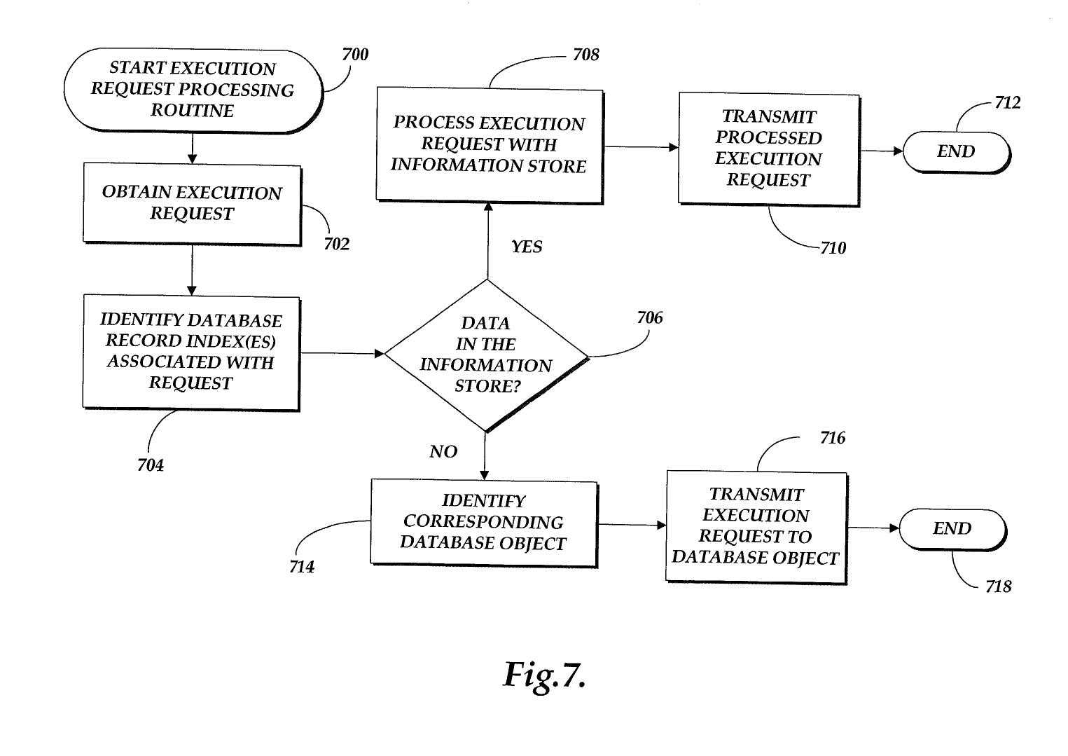

Referring now to FIG. 7, a flow diagram illustrative of an execution request processing routine 700 in accordance with the present invention will be described. At block 702, the client interface application 64 of the information processing server 34 obtains an execution request from a client computing device 32. The execution request can include a request for the return of data from a database, such as return an address for a particular individual. Additionally, in an actual embodiment of the present invention, the execution request includes a request for additional operations on the database that typically require a database record index. The execution requests can include manipulating specific data fields within the database records, comparing different fields within a database record, and the like. However, in accordance with the present invention, the execution request from the client computing device 32 lacks the record database index that would generally be required to perform the execution request.

In an illustrative embodiment of the present invention, the execution request may include a proxy database record index to facilitate identification of an actual database record index by the information processing server 34. In this embodiment, the client computing device 32 issues the execution request that includes a proxy database record index. The proxy database record index cannot be utilized to complete the request, but can be substituted by the information processing server 34, as will be explained below. This embodiment facilitates processing by the information processing server 34, especially if the client computing device 32 is repeating execution requests.

At block 704, the execution request processing application 66 of the information processing server 34 identifies one or more record indexes that correspond to the execution request. In an illustrative embodiment of the present invention, if the execution request includes a proxy record index or other identifier, the information processing server 34 may store a correlation table linking the actual database record index with the proxy database record index. Accordingly, the execution request processing application 66 may utilize a correlation table to locate an actual database record index. At decision block 706, the execution request processing application 66 determines whether the execution request can be processed utilizing the information store 36. In an illustrative embodiment of the present invention, the information processing server 34 may maintain a limited amount, such as the more frequently processed data, in the information store 36 to facilitate the processing of execution requests relating to the data in the information store 36. If the data can be processed utilizing the information store 36, at block 708, the execution request processing application 66 processes the execution request. At block 710, the processed results are transmitted to the client computing device 32 and the routine 700 terminates at block 712. One skilled in the relevant art will appreciate that if a portion of the execution request can be processed by the databases within the information store 36, the execution request may be divided.

Returning to decision block 706, if the execution request cannot be processed utilizing the information store 36, at block 714, the execution request processing application 66 identifies a database object 38 that can process the execution request. At block 716, the database object interface application 68 transmits the execution request to the identified database object 38. In an illustrative embodiment of the present invention, the execution request transmitted by the database object interface application may include the actual database record index required to process the data. Alternately, the execution request may be transmitted with the identifier, such as a proxy database record index, as submitted by the client computing device 32. At block 178, the routine 700 terminates.

One skilled in the relevant art will appreciate that the present invention facilitates the processing of database execution requests without requiring the divulgence of a private database record index. With reference to a security verification embodiment, a security guard computing device 32 may request the verification of an individual's personal data by a information processing server 34 without knowledge of the database record index of the individual's information. Accordingly, the information processing server 34 services the security guard computing device 32 request while mitigating the release of confidential information or the undesired manipulation of the information.

With reference to a commercial transaction embodiment, individuals may perform a variety of financial transactions utilizing the proxy database processing system 30. For example, the information processing server 34 can transfer funds between two individual's bank accounts, without each individual having to release specific account numbers to the other individual.

In another aspect of the present invention, the proxy database processing system 30 may inform one or more of the individual's that data relating to them is being processed. For instance, with reference to a commercial transaction embodiment, an individual may be notified if funds are being transferred to their account. Similarly, an individual may be notified if funds are being transferred from their account and the proxy database processing system 30 may need further confirmation prior to executing the request. With regard to a security monitoring embodiment, the database proxy system 30 may also notify an individual if data corresponding to them is being processed by an external source, such as a security guard computer 32.

While an illustrative embodiment of the invention has been illustrated and described, it will be appreciated that various changes can be made therein without departing from the spirit and scope of the invention.

The embodiments of the invention in which an exclusive property or privilege is claimed are defined as follows:

1. A method for executing a request on a database, the method comprising:
obtaining a database execution request from a client computing device;
identifying a database record index associated with the corresponding record in the database; and
processing the execution request with the identified database record index.

2. The method as recited in claim 1, wherein processing the execution request includes accessing an information store, the information store including at least one database utilized to process the execution request.

3. The method as recited in claim 1, wherein processing the execution request includes transmitting at least a portion of the execution request to a database object.

4. The method as recited in claim 3 further comprising:
obtaining a processed execution request from the database object; and
transmitting the processed execution request to the client computing device, wherein the processed execution request does not include the identified database record index.

5. The method as recited in claim 1 further comprising transmitting the processed execution request to the client computing device, wherein the processed execution request does not include the identified database record index.

6. The method as recited in claim 1, wherein the execution request includes a proxy database record identifier, the proxy database record identifier corresponding to an actual record database identifier.

7. The method as recited in claim 1, wherein the execution request includes transferring funds from a first account to a second account.

8. A computer-readable medium having computer-executable instructions for performing the method recited in claim 1.

9. A computer system including a processor, an operating environment, and a memory, the computer system operable for performing the method recited in claim 1.

10. A system for processing database execution requests, the system comprising:
at least one client computing device operable to generate a database execution request; and
an information processing system operable to obtain the execution request and identify a database record index corresponding to the execution request, wherein the information processing system is further operable to process the execution request with the identified database record index;
wherein the database execution request does not include the identified database record index.

11. The system as recited in claim 10, wherein the information processing system includes an information store, the information store including at least one database utilized to process the execution request.

12. The system as recited in claim 10, wherein the information processing server transmits the processed execution request to the client computing device, wherein the processed execution request does not include the database record index.

13. The system as recited in claim 10 further comprising at least one database object in communication with the information processing system, the database object operable to process the execution request.

14. The system as recited in claim 13, wherein the database object transmits the processed execution request to the information processing system.

15. The system as recited in claim 13, wherein the database object transmits the processed execution request to the client computing device, wherein the processed execution request does not include the database record index.

16. The system as recited in claim 1, wherein the processed execution request includes a proxy database record index, the proxy database record index corresponding to the database record index.

17. The system as recited in claim 1, wherein the execution request includes a proxy database record index corresponding to the database record index.

18. A method for executing a request on a database, the method comprising:
obtaining a database execution request from a client computing device, the execution request including a proxy database record index;
correlating a database record index to the proxy database record index; and
processing the execution request with the database record index.

19. The method as recited in claim 18, wherein processing the execution request includes accessing an information store, the information store including at least one database utilized to process the execution request.

20. The method as recited in claim 18, wherein processing the execution request includes transmitting at least a portion of the execution request to a database object.

21. The method as recited in claim 20, wherein processing the execution request includes transmitting all the execution request to the database object.

22. The method as recited in claim 20 further comprising:
obtaining a processed execution request from the database object; and
transmitting the processed execution request to the client computing device, wherein the processed execution request does not include the database record index.

23. A computer-readable medium having computer-executable instructions for performing the method recited in claim 18.

24. A computer system having a processor, an operating environment and a memory, the computer system operable for performing the method recited in claim 18.
